(19) United States
(12) Patent Application Publication
(10) Pub. No.: US 2007/0112701 A1
(43) Pub. Date: May 17, 2007

(54) Optimization of cascaded classifiers

(75) Inventors: Kumar H. Chellapilla, Sammamish, WA (US); Patrice Y. Simard, Bellevue, WA (US); Michael Shilman, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/204,145

(22) Filed: Aug. 15, 2005

(51) Int. Cl. G06N 3/02

(52) U.S. Cl. 706/15

(57) ABSTRACT

An optimization system comprises a reception component that receives a cascade of classifiers. The system further includes an optimization component communicatively coupled to the reception component, the optimization component receives input relating to one of speed and accuracy of the cascade of classifiers and optimizes the cascade of classifiers based at least in part upon the received input and confidence scores associated with each classifier within the cascade of classifiers. The optimization component can utilize at least one of a steepest descent algorithm, a dynamic programming algorithm, a simulated annealing algorithm, and a branch and bound variant of a depth first search algorithm in connection with optimizing the cascade of classifiers.

### BACKGROUND

Advancements in networking and computing technologies have enabled transformation of computers from low performance/high cost devices capable of performing basic word processing and computing basic mathematical computations to high performance/low cost machines capable of a myriad of disparate functions. For example, a consumer level computing device can be employed to aid a user in paying bills, tracking expenses, communicating nearly instantaneously with friends or family across large distances by way of email, obtaining information from networked data repositories, and numerous other functions/activities. Computers and peripherals associated therewith have thus become a staple in modem society, utilized for both personal and business activities.

A significant drawback to computing technology, however, is its “digital” nature as compared to the “analog” world in which it functions. Computers operate in a digital domain that requires discrete states to be identified in order for information to be processed. In simple terms, information generally must be input into a computing system with a series of “on” and “off” states (e.g., binary code). However, humans live in a distinctly analog world where occurrences are never completely black or white, but always seem to be in between shades of gray. Thus, a central distinction between digital and analog is that digital requires discrete states that are disjunct over time (e.g., distinct levels) while analog is continuous over time. As humans naturally operate in an analog fashion, computing technology has evolved to alleviate difficulties associated with interfacing humans to computers (e.g., digital computing interfaces) caused by the aforementioned temporal distinctions.

Handwriting, speech, and object recognition technologies have progressed dramatically in recent times, thereby enhancing effectiveness of digital computing interface(s). Such progression in interfacing technology enables a computer user to easily express oneself and/or input information into a system. As handwriting and speech are fundamental to a civilized society, these skills are generally learned by a majority of people as a societal communication requirement, established long before the advent of computers. Thus, no additional learning curve for a user is required to implement these methods for computing system interaction.

Effective handwriting, speech, and/or object recognition systems can be utilized in a variety of business and personal contexts to facilitate efficient communication between two or more individuals. For example, an individual at a conference can hand-write notes regarding information of interest, and thereafter quickly create a digital copy of such notes (e.g., scan the notes, photograph the notes with a digital camera, . . . ). A recognition system can be employed to recognize individual characters and/or words, and convert such handwritten notes to a document editable in a word processor. The document can thereafter be emailed to a second person at a distant location. Such a system can mitigate delays in exchanging and/or processing data, such as difficulty in reading an individual's handwriting, waiting for mail service, typing notes into a word processor, etc.

Optical character recognition (OCR) is an exemplary handwriting, speech, and/or object recognition system, which involves translation of images (captured by way of a scanner, digital camera, voice recorder, . . . ) into machine-editable text. More particularly, OCR is often utilized to translate pictures of characters into a standard encoding scheme that represents the characters (e.g., ASCII, Unicode, . . . ). Of course, high accuracy is desirable when translating the images into machine-readable text. Often, however, achieving such accuracy requires utilization of significant amounts of processing power.

While processing power is not problematic with respect to conventional desktop (and laptop) personal computers, portable consumer-level electronic devices such as cellular telephones, personal digital assistants (PDAs), smartphones, and the like may lack requisite processing power to utilize conventional OCR techniques. For instance, a user may wish to utilize a camera telephone to photograph an image, and thereafter perform OCR on such image directly on the telephone. Many conventional portable telephones (or other portable devices) are not associated with sufficient processing power to perform OCR, and devices that are associated with adequate processing power to perform OCR at an accurate level cannot do so in a timely manner. For example, the aforementioned camera telephone may require over one minute to perform OCR on a single image or page utilizing conventional classification techniques.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Described herein are systems, methods, apparatuses, and articles of manufacture that relate to optimizing a cascade of classifiers. The cascade of classifiers can include numerous classifiers that are arranged according to cost associated therewith, where cost refers to time required to perform a classification. In other words, a classifier associated with a lowest cost (e.g., performs classifications most quickly) can be placed at the beginning of the cascade of classifiers, and a classifier associated with a highest cost can be placed at the end of the cascade of classifiers. Each of the classifiers within the cascade can output a classification together with a confidence score. Furthermore, each of the classifiers within the cascade can be associated with a threshold value.

In operation, the cascade of classifiers can receive a plurality of samples, which can be characters, voice samples, images, or any other suitable data suitable for classification. The first classifier within the cascade generates classifications for each of the samples as well as a confidence score associated with the classifications. If the confidence score for a received sample is above the threshold associated with the classifier, then the classifier absorbs the sample. If the confidence score for the sample is below the threshold, then the classifier rejects the sample, and such sample is directed to a subsequent classifier within the cascade. This process continues until all the samples have been absorbed or until a final cascade is reached within the cascade. The final classifier can then be employed to absorb all remaining samples.

The above-described cascade architecture can reduce classification speed without substantial loss in accuracy if the thresholds are optimized. To optimize the cascade of classifiers, one of a speed and accuracy constraint is introduced. In more detail, if a speed constraint is introduced, accuracy of the cascade of classifiers (e.g., the thresholds) will be optimized for the constrained speed. Similarly, if an accuracy constraint is introduced, speed of the cascade of classifiers will be optimized for the constrained accuracy. Various optimization algorithms can be utilized to optimize the cascade of classifiers, including a steepest descent algorithm, a dynamic programming algorithm, a simulated annealing algorithm, and a branch-and-bound variant of depth first search algorithm. In more detail, one or more of these algorithms can be provided with various training data, and the cascade of classifiers can be optimized based at least in part upon the training data (and speed and/or accuracy constraints).

Often, the optimized cascade of classifiers will be utilized on a portable device, such as a cellular telephone, a personal digital assistant, a laptop, or the like. In these devices, processing speed is different when battery power is utilized and when the device is powered by an external power source—thus, disparate optimizations may be desirable for different modes of operation. Accordingly, a table can be generated that includes multiple threshold values for classifiers within the cascade of classifiers depending on a plurality of speed and/or accuracy constraints. To quickly alter optimizations, an appropriate constraint can be selected from the table, and the cascade of classifiers can be quickly updated.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of a system that facilitates optimization of a cascade of classifiers based at least in part upon a classification speed constraint and/or a classification accuracy constraint.

FIG. 2 is an exemplary cascade of classifiers.

FIG. 3 is a block diagram of a system that facilitates optimizing a cascade of classifiers by way of various optimization algorithms.

FIG. 4 is a system that facilitates implementation of a cascade of classifiers upon a client device.

FIG. 5 is a block diagram of a system that facilitates customizing thresholds of cascaded classifiers by way of a table of thresholds that correspond to speed and/or accuracy constraints.

FIG. 6 is a block diagram of a system that facilitates optimizing a cascade of classifiers on a client device.

FIG. 7 is a representative flow diagram illustrating a methodology for optimizing a cascade of classifiers.

FIG. 8 is a representative flow diagram illustrating a methodology for generating a table of disparate optimization parameters based upon different speed and/or accuracy constraints.

FIG. 9 is a representative flow diagram illustrating a methodology for implementing a cascade of classifiers upon a portable device.

FIG. 10 is an exemplary rejection curve of a classifier that can be employed in a cascade of classifiers.

FIG. 11 is an exemplary table of optimizations for a cascade of classifiers.

FIG. 12 is a schematic block diagram illustrating a suitable operating environment.

FIG. 13 is a schematic block diagram of a sample-computing environment.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

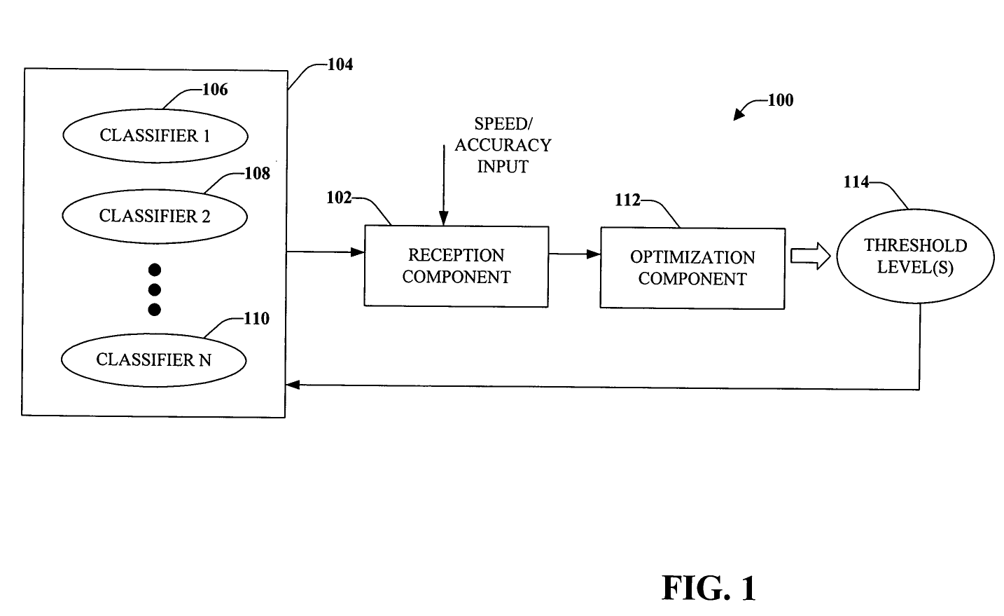

The claimed subject matter will now be described with respect to the drawings, where like numerals represent like elements throughout. Referring now to FIG. 1, a system 100 that facilitates optimization of a combination of classifiers for a given classification speed is illustrated. In more detail, conventional combination classifiers have been created in attempts to maximize accuracy; however, this focus on accuracy negatively affects classification speed, often causing the combination classifier to utilize significant amounts of processing power and take far too long to perform a classification. The system 100 aids in alleviating such deficiencies, as the system 100 can be employed to receive input relating to speed (e.g., a lowest acceptable speed, a series of speeds, . . . ) and thereafter optimize classification accuracy based at least in part thereon. Similarly, the system 100 can receive input relating to accuracy (e.g., a lowest acceptable accuracy, a series of accuracy values, . . . ) and optimize a combination classifier based at least in part upon such input.

The system 100 includes a reception component 102 that receives a combination classifier 104, wherein the combination classifier 104 includes a plurality of individual classifiers 106-110. The classifiers can be any suitable type of classifier, including linear classifiers, such as a classifier designed by way of Fisher's linear discriminant, logistic regression classifiers, Naïve Bayes classifiers, perceptron classifiers, as well as k-nearest neighbor algorithms, boosting algorithms, decision trees, Neural networks, Bayesian networks, support vector machines (SVMs), hidden Markov models (HMVs), and the like. It is understood that this list is not intended to be limitative, as any suitable classifier that can be associated with a confidence score can be utilized on connection with system 100.

The classifiers 106-110 can be arranged in monotonically increasing order in terms of cost—thus, the classifier 106 will be associated with a fastest classification speed within the combination classifier 104 and the classifier 110 will be associated with a slowest classification speed within the combination classifier 104. In operation, the combination classifier 104 can receive a plurality of samples, which are first received by the classifier 106. This classifier 106 is associated with a threshold that causes a particular number of samples to be absorbed by the classifier 106 and the remainder of the samples to be rejected and passed to the classifier 108. The classifier 108 is associated with a lower classification speed than the classifier 106, but receives fewer samples (as a portion of the initial samples are absorbed by the classifier 106). The classifier 108 is also associated with a threshold that causes a number of the remaining samples to be absorbed, and the samples not absorbed are relayed to a next classifier. This process can continue until the final classifier in the cascade (e.g., classifier 110) is reached or until all samples have been absorbed. Using this cascaded classifier architecture, vast increases in classification speed can be achieved without substantial sacrifice in classification accuracy.

The system 100 further includes an optimization component 112 that is communicatively coupled to the reception component 102. The optimization component 112 receives the cascade of classifiers 104 and determines the aforementioned thresholds associated with each of the classifiers 106-110 within the cascade of classifiers 104 (the combination classifier 104). In more detail, a training set of samples can be provided to the cascade of classifiers 104, and each classifier can output a pair—a confidence associated with a classification as well as a classification. Based at least in part upon the confidence scores, the optimization component 112 can determine a confidence threshold to set, wherein the confidence threshold determines which samples are absorbed by a classifier and which are rejected (and passed to a subsequent classifier within the cascade of classifiers 104). The optimization component 112 can automatically determine threshold levels 114 based upon a training set of data and the cascade of classifiers 104, and thereafter apply such threshold levels 114 to the cascade of classifiers 104. The threshold levels are selected 114 to maximize accuracy given a speed constraint and/or maximize speed given an accuracy constraint.

The optimization component 112 can further output a plurality of thresholds given disparate speed and/or accuracy constraints. For instance, a table that includes speed constraints, accuracy constraints, and thresholds associated with the speed and accuracy constraints can be generated, and a user can select a desired speed and/or accuracy. The thresholds associated with the selection can then be applied to the classifiers 106-110 within the cascade of classifiers 104. In a detailed example, the optimization component 112 can output a table that includes thresholds associated with speed and/or accuracy constraints. The table can be provided to a client, such as a cellular telephone or a personal digital assistant, wherein a user of such device may wish to perform optical character recognition (OCR) upon an image by way of the cascade of classifiers 104. Depending upon user wishes with respect to speed/accuracy of classification, the user can access the table and cause thresholds associated with the classifiers 106-110 within the cascade of classifiers 104 to be implemented based upon selected speed/accuracy. In a similar example, a client device can automatically select speed/accuracy constraints based at least in part upon processing power, current processes being undertaken, and/or whether battery power is being utilized. Moreover, the optimization component 112 can automatically optimize the cascade of classifiers based at least in part upon error data associated with a training set utilized to train the cascade of classifiers 104.

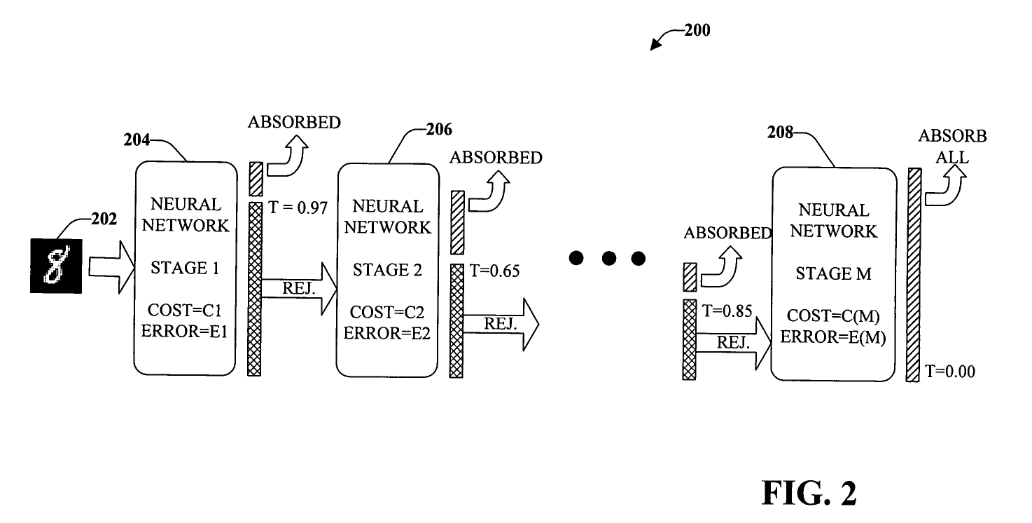

Now referring to FIG. 2, an exemplary cascade of classifiers 200 is illustrated, wherein each classifier within the cascade of classifiers 200 is associated with a particular threshold as determined by the optimization component (FIG. 1). In this example, the classifiers are shown as being neural networks; however, as described above, any suitable classifier that can output a confidence score can be utilized within the cascade of classifiers 200. In more detail, a plurality of samples 202 are provided to a first classifier 204 that is associated with a cost C1 (in terms of classification speed) and an error (or accuracy) E1. A confidence threshold (T=0.97) is associated with the first classifier 204, and causes at least a portion of the plurality of samples 202 to be absorbed (e.g., classifications associated with a confidence above the threshold are retained). Samples that are not absorbed are rejected and delivered to a second classifier 206. The second classifier 206, like the first classifier 204, is associated with a cost (C2), which can be greater than the cost C1 that is associated with the first classifier 204. Similar to the first classifier 204, the second classifier can be associated with a threshold T=0.65, which causes at least a portion of the plurality of samples 202 rejected by the first classifier 204 to be absorbed. Samples not absorbed by the second classifier 206 can then be passed to a next classifier within the cascade of classifiers 200.

The process can be completed until the plurality of samples 202 are absorbed or until a last classifier 208 within the cascade of classifiers 200 is reached. The classifier 208 is associated with a threshold T=0, thereby causing each sample to be absorbed. The classifier cascade 200 thus can include faster, less accurate classifiers towards the beginning of the cascade 200 and slower, more accurate classifiers near the beginning of the cascade of classifiers 200. Through arranging the classifiers in such a manner and determining thresholds associated with the classifiers 204-208 within the cascade of classifiers 200, processing time associated with the plurality of samples 202 can be reduced when compared to conventional classification techniques. The gains in speed are determined by costs, errors, and thresholds at each of the classifiers 204-208, wherein lower cost implies a faster classifier stage.

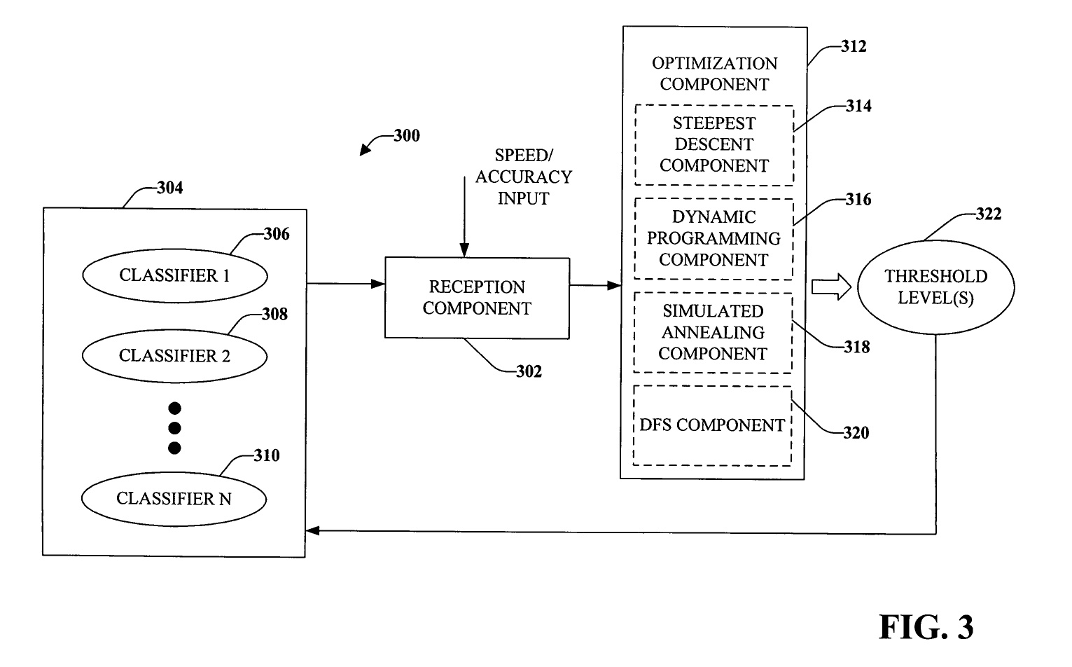

Now turning to FIG. 3, a system 300 that facilitates optimization of a cascade of classifiers based upon input relating to speed and/or efficiency is illustrated. The system 300 includes a reception component 302 that receives a cascade of classifiers 304, wherein the cascade of classifiers includes a plurality of classifiers 306-310 (or classifier stages). The classifiers 306-310 can be arranged in any suitable manner, such as in a manner that fastest classifiers are at the beginning of the cascade or classifiers 304 and slowest classifiers are at the end of the cascade of classifiers 304. In other words, the classifiers 306-310 can be arranged such that costs monotonically increase from beginning to end of the cascade of classifiers 304. Mathematically, the classifiers can be arranged according to the following: C₁≦C₂≦ . . . ≦C_{M}, where M is a number of classifiers (stages) within the cascade of classifiers 304 and C₁ is a computational cost associated with the ith stage. Given such ordering, costs can be normalized such that C₁=1.0. Unlike costs, errors may or may not be monotonically decreasing within the cascade.

An optimization component 312 is communicatively coupled to the reception component 302 and optimizes the cascade of classifiers 304 by computing thresholds associated with the classifiers 306-310 based at least in part upon desired speed and/or accuracy of the cascade of classifiers 304. Thus, the optimization component 312 locates an optimal cascade with an error less than a predefined value eₘₐₓ, which can be larger than an error incurred by a classifier within the cascade 304 associated with the least amount of error. The search space of the solutions can be defined as S={t₁}×{t₂}× . . . ×{t_{M}}, where tᵢ is a set of thresholds for a stage i. An optimal threshold vector can be given by:
T*=arg min{C(T)|T∈S, e(T)≦e_{max}.}
The optimal cost is C(T*) and corresponding speedup is

$$\frac{{C}_{M}}{C ( T *)} .$$

For instance, during optimization a set of input samples, {xᵢ} can be utilized to evaluate cost, C(T) and error rate, e(T), of the cascade for each candidate threshold vector, T. If a stage rejects all samples (e.g., does not absorb any samples) then it can be pruned from the cascade and thus adds no cost to the cascade. Thus, it can be discerned that some stages or classifiers can be dropped completely from a cascade, and that some stages or classifiers can be truncated. It can also be discerned that C(T*) can be no lower than C₁. At the other extreme, a maximum possible expected cost per input sample can be given by:
max C(T)=(NC₁+(N−1)C₂+ . . . +(N−M)C_{M})/N,
where N is the total number of samples (or the number of thresholds for each stage). For N>>M, the maximum error can be given by:
max C(T)=C₁+C₂+ . . . +C_{M.}

The optimization component 312 can include various components to locate solutions to the aforementioned problems. For example, the optimization component 312 can include a steepest descent component 314, a dynamic programming component 316, a simulated annealing component 318, and/or a depth first search (DFS) component 320. The steepest descent component 312 and the dynamic programming component 314 can be employed to generate approximate solutions quickly, while the simulated annealing component 318 and the depth first search component 320 can be employed to locate optimal solutions. However, at any finite number of iterations, a best solution may only be approximate.

Now providing more detail with respect to the steepest descent component 314, such component 314 can include a steepest descent algorithm that is initiated with T₀=[1,1 . . . ,1,0], e.g., every stage rejects all samples except for a final stage (which absorbs all samples). Such a solution satisfies the eₘₐₓ constraint and has a cost C(T₀)=C_{M}. During each iteration, a change in cost (ΔCᵢ, i=1,2, . . . ,M) and a change in error (Δeᵢ, i=1,2, . . . ,M) are computed by lowering each threshold (tᵢ) to a next possible value while maintaining values of all other thresholds. If the stages are arranged so that costs increase monotonically, then ΔCᵢ>0, i=1,2, . . . ,M. If an amount of error decreases for any i (e.g., Δeᵢ<0), the best such i with a lowest Δeᵢ can be selected for update. If all Δeᵢ>0, the i associated with a lowest cost change per unit error change=

$$\frac{Δ {C}_{i}}{Δ e}$$

is selected for update. A selected threshold can be updated to a next lower value and the process is iterated. Search can be terminated when a best possible update places an error above eₘₐₓ. A steepest descent algorithm utilized by the steepest descent component 314 may be sensitive to local optima and used as a baseline for comparing algorithms. Utilizing the above-described algorithm, each update can take at most O(M) evaluations with at most MN evaluations. Due to incremental updates to the thresholds during successive evaluations, cost and error evaluation can be completed efficiently by remembering which samples were absorbed at each of the stages and which samples are affected by a threshold update. The total running time is bounded by O(M² N).

The optimization component 312 can also or alternatively utilize the dynamic programming component 316 to determine thresholds. The dynamic programming component 316 can utilize a dynamic programming algorithm that builds a cascade by iteratively adding new stages. For instance, the algorithm can begin with a two stage cascade containing the first and last stages, S₁ and S_{M}, respectively. It can be determined that a two stage cascade has at most N possible threshold vectors. Each threshold vector can represent a unique solution with a different second last stage threshold. For instance, the threshold vectors can be represented as N paths of length one, each ending at a unique threshold. The dynamic programming component 316 can evaluate each of the N paths, and stage S₂ can be inserted between stages S₁ and S_{M}. Each of the existing N paths can be extended in N possible ways through S₂, and the dynamic programming component 316 can evaluate all such N² extensions. For each threshold in S₂, a best path extension (among the N² possible extensions) can be selected and retained, which results in N paths of length two each passing through a disparate threshold in S₂ and representing a different cascade with three stages. The process of adding a stage can be repeated M−2 times to obtain a set of N paths representing cascades with M stages. A best path among the remaining N paths can be selected as a final solution. The above-described algorithm will not necessarily locate the optimal solution because only N paths are retained at each iteration. The running time for the above-described algorithm is O(MN²).

The optimization component 312 can also or alternatively use the simulated annealing component 318 to automatically assign thresholds to the classifiers 304-310. The simulated annealing component can employ a simulated annealing algorithm that simultaneously optimizes all thresholds in a cascade of M stages. Similar to the steepest descent algorithm described above, the initial solution can be T₀. At any given temperature λ each threshold tᵢ can be updated to a neighbor that is η= round(G(0,λ)) steps away, where G(0,λ) is a zero mean Gaussian random variable with standard deviation λ, where η can be positive or negative. Any thresholds that fall outside valid limits (threshold indices: 1-N or threshold values 0-1) are reset to the limit violated. The initial temperature can be set to N (the number of samples or thresholds for each stage) and a Metropolis algorithm can be utilized to accept better solutions. Further, any solutions that do not satisfy criterion associated with eₘₐₓ can also be rejected during the updates. Temperature can be continuously annealed down to zero with possibly a maximum of a few million evaluations (E). The running time for the above-described algorithm is O(EM).

The optimization component 312 can also or alternatively employ the DFS component 320 to determine thresholds for the cascade of classifiers. Unlike the steepest descent component 314, the dynamic programming component 316, and the simulated annealing component 318, the DFS component 320 can be employed to exactly optimize rejection thresholds. The DFS component 320 can employ a branch-and-bound variant of depth first search to determine the thresholds, wherein each node in a search can be a partial configuration of thresholds. A start node corresponds to a state in which all thresholds are left unassigned; each of its child nodes corresponds to a particular setting of thresholds for the first classifier in the cascade of classifiers 304. Each of their child nodes, in turn, can correspond to settings of thresholds for a second classifier in the cascade of classifiers 304, and so on. If at any point the DFS component 320 cannot possible achieve a maximum error or a minimum costs, the DFS component 320 skips. Therefore, large sections of search space can be pruned. A goal state is reached when the DFS component 320 achieves a fully assigned configuration, and the DFS component 320 terminates when it has searched or safely pruned an entire space. An algorithm utilized by the DFS component 320 can exactly optimize quantized rejection thresholds. In quantized DFS, rather than attempting to split at every example, values can be sorted by confidence and split at every (N/Q)th example, where N is a total number of examples and Q is a desired quanta. A percentile-based splitting distributes data evenly amongst the quanta and provides a simple and natural quantized resolution. Below is an exemplary DFS algorithm in pseudo code that can be employed by the DFS component 320:

```
liveSet = { the set of all examples };
DFS*(0, 0, 0, liveSet);
DFS*(inError, inCost, stage, liveSet) {
    if(inError > _maxError ∥ inCost > _minCost) return;
    // first, try to absorb everything in this stage
    cost = inCost + Cost(stage, liveSet);
    error = inError + Error(stage, liveSet);
    if(error < _maxError && cost < _maxCost) // goal state
      _maxCost = cost; // save thresholds
    // try to absorb some of the examples
    foreach(t in Thresholds(stage)) {
      subSet = Threshold(t, liveSet);
      DFS*(inError + Error(stage, subSet), cost, stage+1,
      liveSet−subSet);
    }
    // absorb none of the examples
    DFS*(inError, inCost, stage+1, liveSet);
}
```

The optimization component 312 can include and/or utilize any of the steepest descent component 314, the dynamic programming component 316, the simulated annealing component 318, and the DFS component (or a combination thereof) to output threshold level(s) 322 for the classifiers 306-310 within the cascade of classifiers 304. The threshold level(s) 322 can then be applied to the cascade of classifiers 304. As described above, a plurality of threshold(s) can be created, wherein the threshold values correspond to disparate error levels and/or timing constraints.

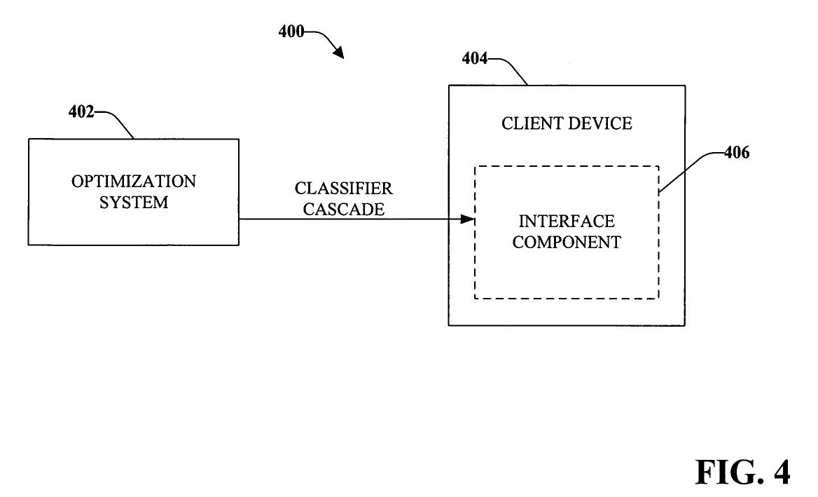

Referring now to FIG. 4, a system 400 that facilitates receipt and utilization of a cascade of classifiers optimized for one of speed and accuracy is illustrated. The system 400 includes an optimization system 402, which can operate in a manner substantially similar to that as described with respect to the optimization systems 100 (FIG. 1) and 300 (FIG. 3). In other words, the optimization system 402 can be utilized to optimize a cascade of classifiers given either a speed or accuracy constraint. A cascade of classifiers can be delivered from the optimization system to a client 404, which includes an interface component 406 that facilitates receipt and implementation of the cascade of classifiers upon the client device 404. For instance, the interface component 406 can be an antenna, wireless card, or the like that facilitates receipt of the cascade of classifiers from the optimization system 402. Thus, the optimization system 402 can lie upon a server, and the output cascade of classifiers (optimized for one of speed and accuracy) can be implemented upon the client 404. It is understood, however, that the optimization system 402 can be existent upon the client device 404, together with any training data needed to optimize a cascade of classifiers. Accordingly, the interface component 406 can also be hardware and/or software that enables implementation of the cascade of classifiers with a processing unit on the client device 404.

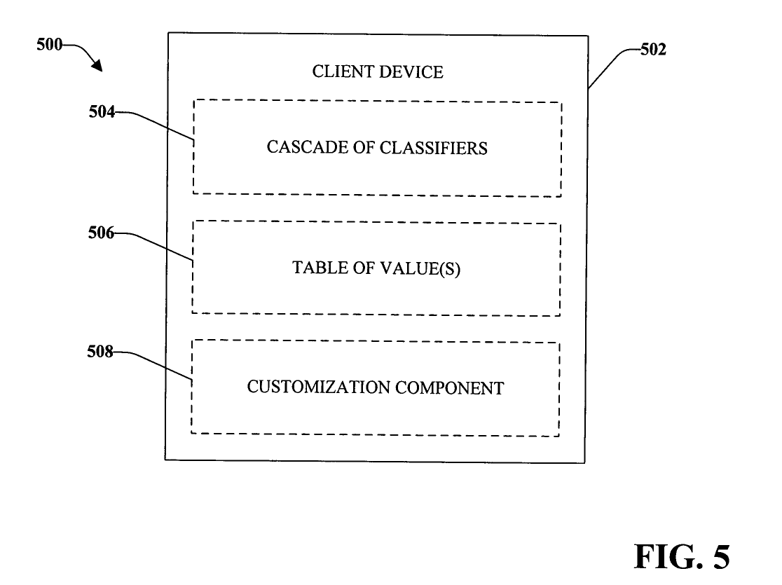

Turning now to FIG. 5, a system 500 that facilitates user-customization with respect to optimizing a cascade of classifiers is illustrated. The system 500 includes a client device 502, which can be a cellular telephone, a smartphone, a personal digital assistant, a camera telephone, a digital camera, or any other suitable device that can include a processing unit. The client device 502 includes a cascade of classifiers 504, which can be optimized by way of an optimization system described above. The client device 502 can further include a table of value(s) 506, wherein the value(s) relate to optimization of the cascade of classifiers 504 given various constraints with respect to classification speed and/or classification accuracy. For instance, a particular processing speed can be associated with specific threshold values for the cascade of classifiers 504. Similarly, a particular accuracy (e.g., 2 percent error threshold) can be associated with threshold values for the cascade of classifiers 504. In still more detail, the table of values 506 comprises threshold values that optimize the cascade of classifiers 504 for particular speeds and/or accuracies.

The client device 502 can also include a customization component 508 that facilitates user customization of an optimization of the cascade of classifiers 504. For instance, a user, during a particular application of the client device 502, may wish for a high accuracy. Accordingly, the user can, through the customization component 508, select a desirable accuracy from the table of value(s) 506. Optimized threshold values corresponding to the selected accuracy can then be implemented within the cascade of classifiers 504. In another example, the user may wish to cause the cascade of classifiers 504 to operate at a high speed. The user can select the desired speed from the table of value(s) 506 by way of the customization component 508, and threshold value(s) associated with the selected speed can be implemented within the cascade of classifiers 504. Therefore, the cascade of classifiers 504 can be optimized for accuracy given the selected classification speed.

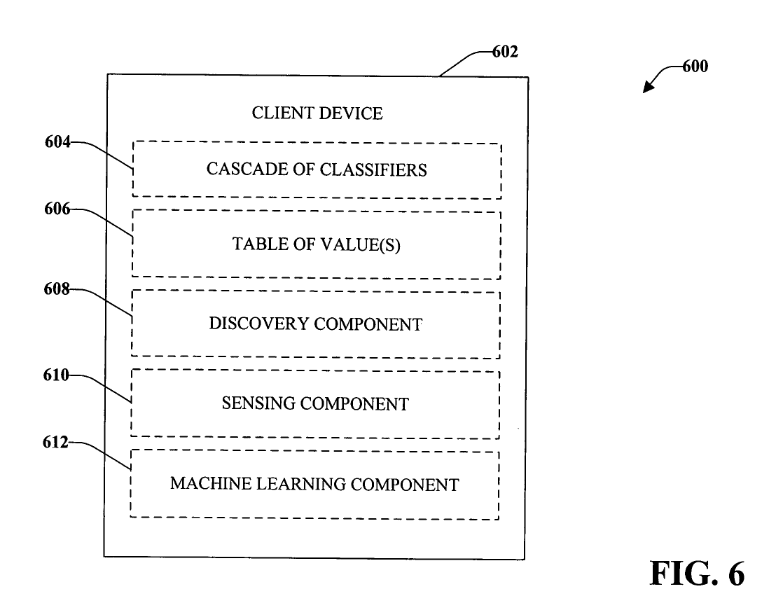

Now turning to FIG. 6, a system 600 that facilitates customized optimization of a cascade of classifiers is illustrated. The system 600 includes a client device 602 that can perform a classification task, such as optical character recognition (OCR), voice recognition, fingerprint matching, facial feature recognition, any suitable image matching, and the like. In particular, the client device 602 can be associated with sufficient memory and processing capabilities to perform complex classifications. The client device 602 includes a cascade of classifiers 604 that can be arranged so that cost associated with classifiers therein is monotonically increasing. The client device 602 can also include a table of value(s) 606, wherein the table of value(s) relates speed of classification and/or accuracy of classification with threshold values that optimize the cascade of classifiers 604 for such speed of classification and/or accuracy of classification.

The client device 602 can further include a discovery component 608 that discovers parameters associated with the client device 602. For instance, the discovery component 608 can determine and/or have knowledge of processing power associated with the client device 602. Furthermore, the discovery component 608 can determine and/or have knowledge of memory associated with the client device 602. Based at least in part on the parameters, the discovery component can select a speed and/or accuracy from the table of value(s) 606, and the cascade of classifiers 604 can be optimized through implementation of threshold value(s) that correspond to the selected speed and/or accuracy. The client device 602 can also comprise a sensing component 610 that can detect whether the client device 602 is acting on battery power, an amount of battery power remaining, and/or whether the client device 602 is connected to an external power source. Based upon this determination, the sensing component 610 can select a speed and/or accuracy within the table of value(s) 606, and the cascade of classifiers 604 can be optimized with threshold values that correspond to the selected speed and/or accuracy.

The client device 602 can further include a machine-learning component 612 that can make inferences in connection with determining which threshold value(s) to apply to the cascade of classifiers 604. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

For instance, the machine-learning component 612 can monitor use of the client device 602 over time, and automatically select timing and/or accuracy constraints by way of inference. In a more detailed example, the client device 602 can be a cellular telephone, and the user may receive several calls during a particular period of time on certain days. Based upon such information, the machine-learning component 612 can automatically cause the cascade of classifiers 604 to be optimized for a particular speed (and sacrifice accuracy) to ensure that the client device 602 isn't overworked. Other suitable inferences are also contemplated by the inventors, and are intended to fall under the scope of the hereto-appended claims.

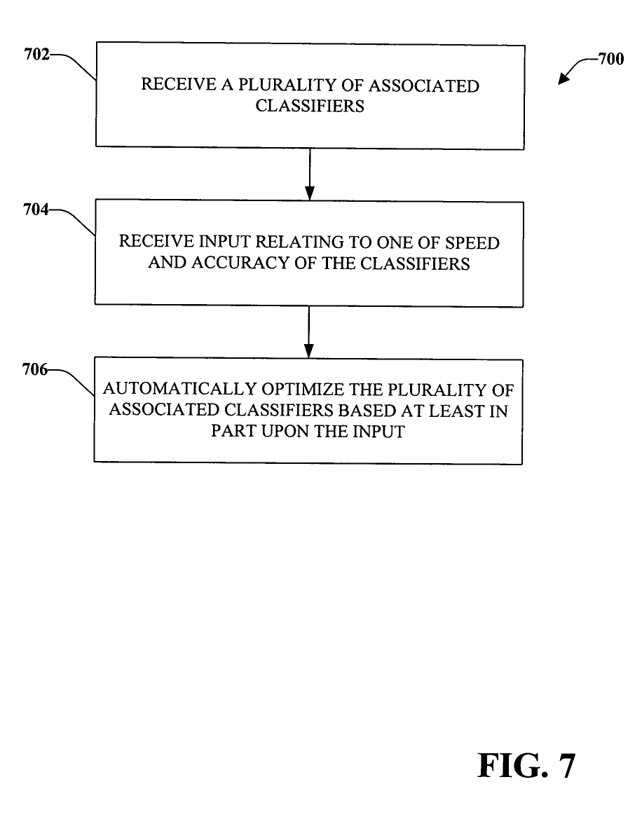

Referring now to FIGS. 7-9, methodologies in accordance with the claimed subject matter will now be described by way of a series of acts. It is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 7, a methodology for optimizing a cascade of classifiers by way of determining threshold values associated with classifiers within the cascade of classifiers is illustrated. At 702, a plurality of associated classifiers are received. For example, the classifiers can be arranged so that costs (classification time requirements) associated therewith are increasing monotonically. In another example, an order of associated classifiers can be automatically determined by way of a heuristic approach and/or through enumeration of the plurality of classifiers.

At 704, input relating to one of speed and accuracy of the classifiers is received. For instance, the input can be a speed constraint associated with speed of classifications (e.g., OCR completed on one page in five seconds). In another example, the input can be an error tolerance threshold (e.g., three percent error tolerance). At 706, the plurality of associated classifiers are automatically optimized based at least in part upon the received input. More particularly, thresholds associated with each of the classifiers that dictate which classifications are absorbed and which classifications are rejected and passed to an associated classifier can be determined based upon the received input. For instance, a steepest descent algorithm, a dynamic programming algorithm, a simulated annealing algorithm, and/or a branch-and-bound variant of a depth first search algorithm can be employed to determine the thresholds associated with the plurality of classifiers.

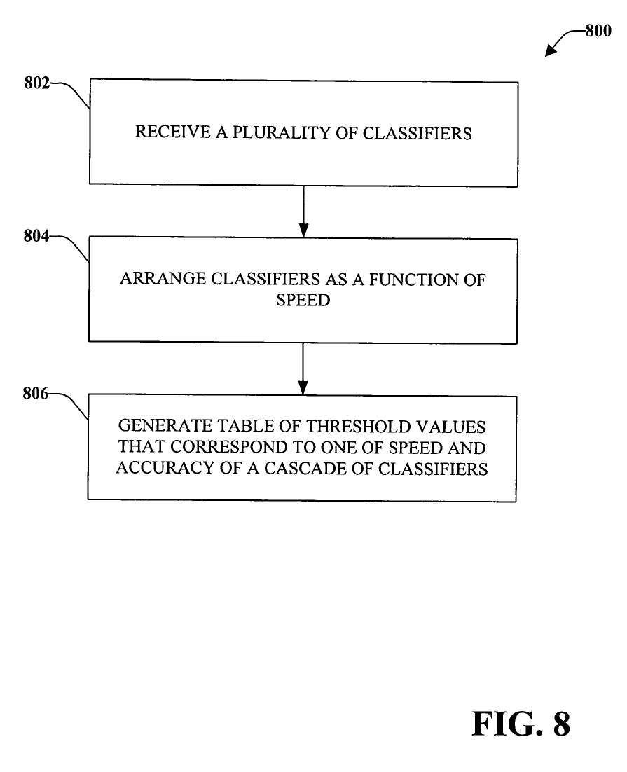

Now turning to FIG. 8, a methodology 800 for optimizing a cascade of classifiers based upon speed and accuracy constraints is illustrated. At 802, a plurality of classifiers are received, wherein the classifiers can include linear classifiers, such as a classifier designed by way of Fisher's linear discriminant, logistic regression classifiers, Naïve Bayes classifiers, perceptron classifiers, as well as k-nearest neighbor algorithms, boosting algorithms, decision trees, Neural networks, Bayesian networks, support vector machines (SVMs), hidden Markov models (HMVs), and the like.

At 804, the classifiers are arranged as a function of speed. More specifically, classifiers that are faster (and typically less accurate) can be placed near a beginning of a cascade of classifiers, and classifiers that are slower (and typically more accurate) can be positioned near an end of the cascade of classifiers. At 806, a table of threshold values that correspond to one of speed and accuracy is automatically generated. For example, disparate accuracy constraints can correspond to different threshold values associated with the cascade of classifiers. In more detail, a classifier within the cascade of classifiers can output a confidence score with each classification. If the confidence lies above a threshold, the sample being classified will be absorbed by the classifier. If the confidence falls below the threshold, the sample will be rejected and passed to a subsequent classifier within the cascade. Threshold values will be different for disparate accuracy and/or speed constraints, and the table can include threshold values that correspond to different accuracy and/or speed constraints. This table can later be employed to quickly optimize the cascade of classifiers upon a client device.

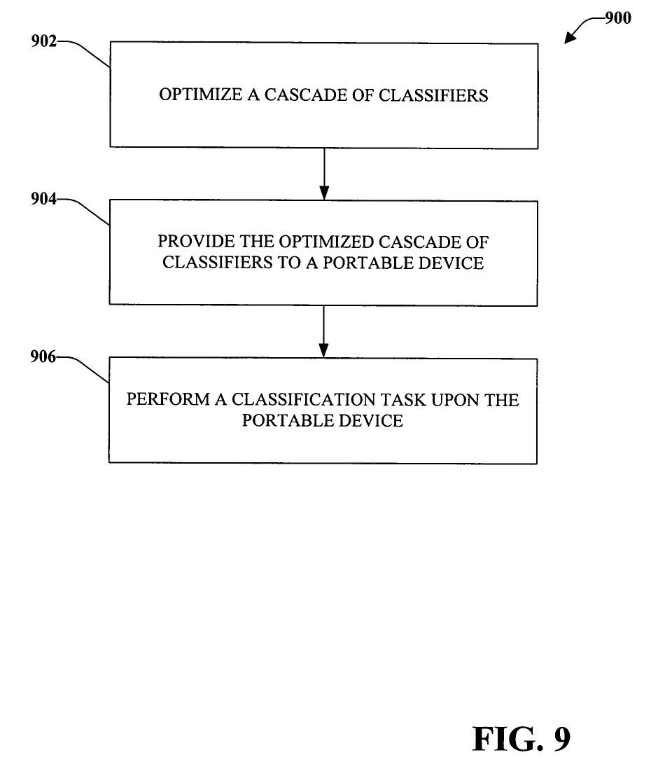

Turning now to FIG. 9, a methodology 900 for implementing an optimized cascade of classifiers upon a portable device is illustrated. At 902, a cascade of classifiers is optimized for a particular speed and/or a particular accuracy. The optimization relates to determining threshold values associated with each classifier within the cascade of classifiers, as described above. For instance, the optimization can be completed by utilizing one or more of a steepest descent algorithm, a dynamic programming algorithm, a simulated annealing algorithm, and a branch-and-bound variant of depth first search algorithm. At 904, the optimized cascade of classifiers is provided to a portable device. In one example, an optimization system can exist upon a server, and an optimized classifier can be delivered to the portable device by way of any suitable network. In a disparate example, an optimization system can exist on the portable device, and an optimized cascade of classifiers output by the system can be implemented on the portable device. The portable device can be, but is not limited to being, a cellular telephone, a smartphone, a camera telephone, a personal digital assistant, and a laptop computer.

At 906, a classification task is performed upon the portable device through utilization of the optimized cascade of classifiers. For example, optical character recognition, voice recognition, or any other suitable classification task can be performed. The classification can operate as follows: the portable device can receive a plurality of samples, all of which are delivered to a first classifier within the cascade of classifiers. The first classifier performs classifications upon the samples and outputs a confidence score associated with the classifications. The first classifier is also associated with a threshold (determined during optimization), and if the confidence lies above the threshold, the first classifier absorbs a corresponding sample. If the confidence lies below the threshold, the sample is rejected and passed along to a subsequent classifier within the cascade. The process repeats until each of the plurality of samples has been absorbed or until a final classifier is reached in the cascade (the final classifier absorbs all remaining samples).

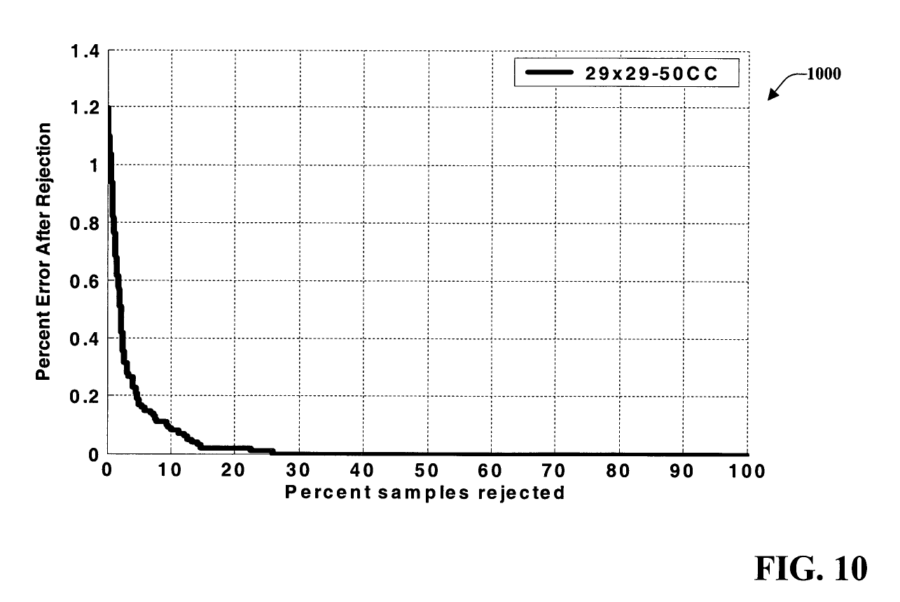

Now turning to FIG. 10, an exemplary rejection curve 1000 for a particular classifier that can be utilized in a cascade of classifiers is illustrated. The rejection curve 1000 is associated with a conventional neural network with fifty hidden nodes. It can be seen that the rejection curve 1000 is monotonically decreasing, indicating that a higher the confidence the less likely that a character will be misclassified. On one data set, the classifier achieves an error rate of 1.25% —however, the error rate can be improved by rejecting a small percentage of the data (and passing such rejections to a disparate classifier).

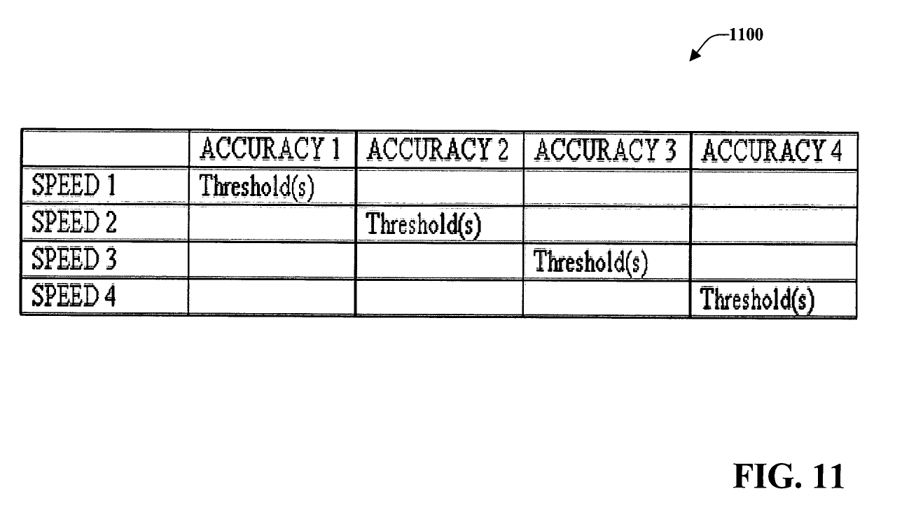

Now turning to FIG. 11, an exemplary table 1100 that can be utilized to quickly optimize a cascade of classifiers is illustrated. The table 1100 includes values associated with speed as well as values associated with accuracy. A faster classification speed is associated with a lower classification accuracy. Thus, a tradeoff exists between speed and accuracy, and a cascade of classifiers can be optimized based at least in part upon either.

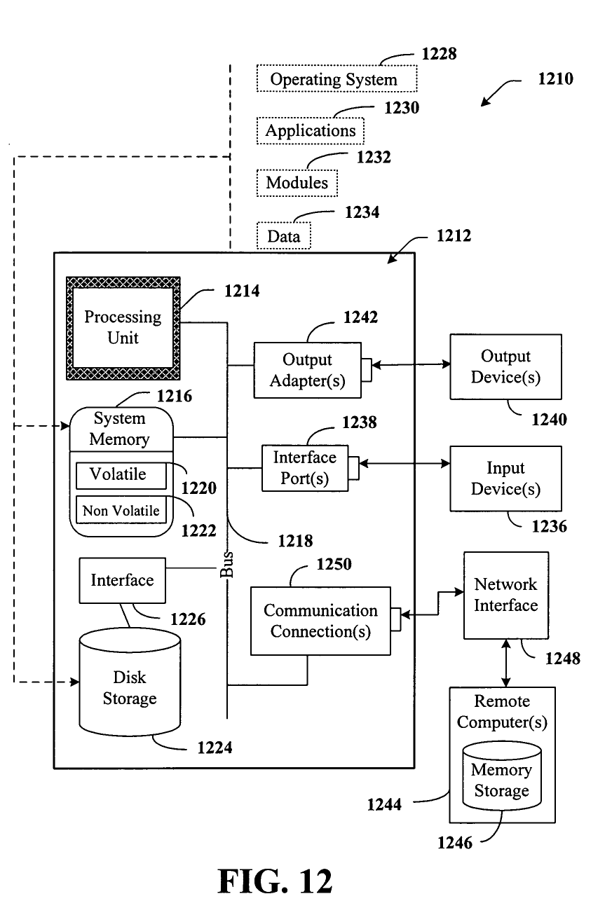

In order to provide additional context for various aspects of the subject invention, FIG. 12 and the following discussion are intended to provide a brief, general description of a suitable operating environment 1210 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

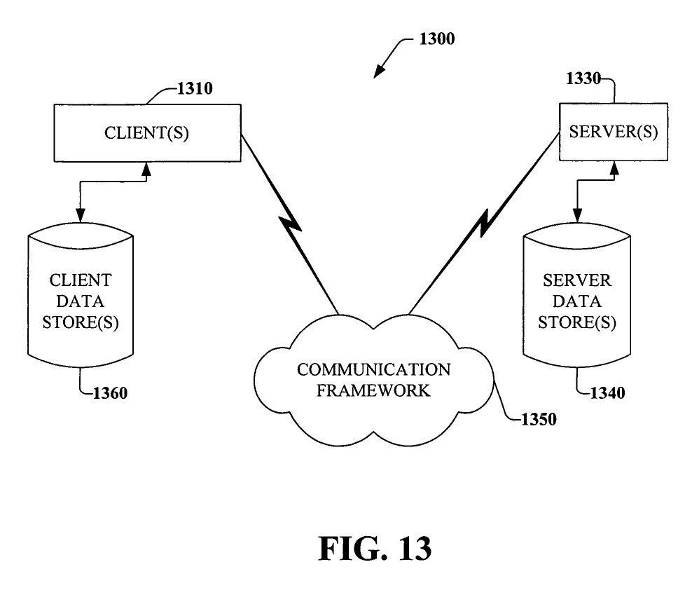

FIG. 13 is a schematic block diagram of a sample-computing environment 1300 with which the subject invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the subject invention, for example. One possible communication between a client 1310 and a server 1330 can be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the claimed subject matter. It is, of course, not possible to describe every conceivable combination of components or methodologies for purposes of describing such subject matter, but one of ordinary skill in the art may recognize that many further combinations and permutations are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer implemented optimization system comprising the following computer executable components:
a reception component that receives a cascade of classifiers and input relating to speed and accuracy of the cascade of classifiers, wherein the cascade of classifiers includes a plurality of individual classifiers; and
an optimization component communicatively coupled to the reception component, the optimization component receives speed/accuracy input from the reception component and automatically optimizes the cascade of classifiers based at least in part upon the received input, confidence scores associated with each classifier within the cascade of classifiers, and error status corresponding to a training set associated with the cascade of classifiers.

2. The optimization system of claim 1, the optimization component determines a table of threshold values associated with each classifier within the cascade of classifiers, the threshold values are based at least in part upon the received input.

3. The optimization system of claim 2, the table of threshold values is quantized to improve on at least one of optimization speed or deployment performance.

4. The optimization system of claim 1, the optimization component utilizes at least one of a steepest descent algorithm, a dynamic programming algorithm, a simulate annealing algorithm, and a branch and bound variant of a depth first search algorithm in connection with optimizing the cascade of classifiers.

5. The optimization system of claim 1 resident upon a server.

6. The optimization system of claim 5, further comprising an interface component that facilitates reception of the optimized cascade of classifiers at a client.

7. The optimization system of claim 1, the optimization component generates a table of optimizations, corresponding values within the table of optimizations represent tradeoffs between speed of the cascade of classifiers and accuracy of the cascade of classifiers.

8. The system of claim 7, further comprising a customization component that facilitates user-customization of the optimized cascade of classifiers based at least in part upon a selection of at least one value from within the table.

9. The system of claim 7, further comprising a discovery component that discovers processing parameters upon a client device, at least one value from within the table selected based at least in part upon the discovered processing parameters.

10. The system of claim 1, the cascade of classifiers arranged as a function of speed of each classifier within the cascade of classifiers.

11. The system of claim 1, the cascade of classifiers arranged as a function of accuracy of each classifier within the cascade of classifiers.

12. The system of claim 1, the cascade of classifiers optimized for one of optical character recognition, voice recognition, and image recognition.

13. A computer-implemented method for optimizing a combination of classifiers comprising the following computer-executable acts:
receiving a plurality of associated classifiers;
receiving input relating to speed and accuracy of the plurality of associated classifiers; and
automatically optimizing the plurality of associated classifiers based at least in part upon the received input.

14. The method of claim 13, further comprising automatically determining an order of the plurality of associated classifiers.

15. The method of claim 13, further comprising employing at least one of a steepest descent algorithm, a dynamic programming algorithm, a simulate annealing algorithm, and a branch and bound variant of a depth first search algorithm in connection with optimizing the plurality of associated classifiers.

16. The method of claim 13, further comprising implementing the optimized plurality of associated classifiers upon a portable device.

17. The method of claim 16, the portable device is one of a camera, a portable telephone, a laptop computer, and a personal digital assistant.

18. The method of claim 13, further comprising arranging the plurality of classifiers in a monotonically increasing manner in terms of cost.

19. The method of claim 13, automatically optimizing the plurality of associated classifiers comprises determining a table of threshold values associated with each of the plurality of associated classifiers, the threshold values are based at least in part upon input relating to one of speed and accuracy of the combination of classifiers.

20. A computer-implemented optimization system, comprising:
means for receiving input relating to one of speed and accuracy of a cascade of classifiers wherein the cascade of classifiers includes a plurality of individual classifiers; and
means for automatically optimizing the cascade of classifiers based at least in part upon the received input and confidence scores associated with each classifier within the cascade of classifiers.
